(19) United States
(12) Patent Application Publication
(10) Pub. No.: US 2007/0297584 A1
(43) Pub. Date: Dec. 27, 2007

(54) Computer enabled method and apparatus for connecting individuals via telephone

(76) Inventor: Mahesh Lalwani, Cupertino, CA (US)

Correspondence Address: MORRISON & FOERSTER LLP, 755 PAGE MILL RD, PALO ALTO, CA, 94304-1018, US

(21) Appl. No.: 11/809,522

(22) Filed: Jun. 1, 2007

Related U.S. Application Data
(60) Provisional application No. 60/813,659, filed on Jun. 14, 2006.

(51) Int. Cl. H04M 11/00

(52) U.S. Cl. 379/114.03; 379/142.02

(57) ABSTRACT

A computer enabled system and method for social networking. While the present system is computer based in the sense that the registration and setup of members joining the social network may be done through the Internet and a computer server, the actual subsequent interactions between the members of the network are via the telephone so that they can actually speak with one another. The telephone calls are routed through the system so as to preserve the anonymity of both the caller and the callee so that they can speak to each other without revealing personal information, including their own telephone number, unless so desired. This allows like-minded people to find each other and talk over the telephone without previously knowing each other or waiting for introductions.

### CROSS-REFERENCE TO RELATED APPLICATIONS

This application claims priority to U.S. Provisional Patent Application Ser. No. 60/813,659, filed Jun. 14, 2006, incorporated herein by reference in its entirety.

### FIELD OF THE INVENTION

This invention relates to computer enabled social networking.

### BACKGROUND OF THE INVENTION

Computer enabled social networking is well known. Examples are Myspace, Facebook, etc., which allow people to interact with others typically via the Internet, thereby to form online relationships. There is currently a proliferation of such social networking systems. However generally they are fully computer based, that is all the interactions are by email and instant messaging.

### SUMMARY

The present inventor has identified a significant shortcoming with this process. In accordance with this disclosure, a computer enabled social networking system connects people, not via computer, but via telephone. Computer interactions, such as email and instant messaging, have significant drawbacks in terms of not being real time for email, not hearing the other person's voice, and requiring the intermediary of each user's computer. The present inventor has determined that it would be useful to improve such a system by providing telephonic connections between the individuals. While the system is computer based, the actual communications between the individuals are conventional telephone calls. However the telephone calls are not placed by either individual but by the central system, thus preserving the anonymity of the caller and callee unless and until they desire to exchange actual telephone numbers. This allows database, internet, speech, and telecommunication processes to be united to create a local, regional, and global community where people can connect with others over the telephone without disclosing their telephone numbers or personal information until so desired. This creates a social and professional networking platform in order to locate and communicate with people with similar interest and also talk to them over the telephone.

### BRIEF DESCRIPTION OF THE DRAWINGS

FIG. 1 shows an overview of the structure of the present system.

FIG. 2 shows a home page of a website associated with the present system.

FIG. 3 shows a profile page of the present system.

FIG. 4 shows a telephone call log of the present system.

FIG. 5 shows a buddy ratings page of the present system.

FIG. 6 shows a refer friends page of the present system.

FIG. 7 shows a referrals page of the present system.

FIG. 8 shows a feedback review page of the present system.

FIG. 9 shows a billing information page of the present system.

FIG. 10 shows an upgrade service page of the present system.

FIGS. 11 and 12 show flow of a telephone call in accordance with the present method.

FIG. 13 shows additional detail of the system of FIG. 1.

### DETAILED DESCRIPTION

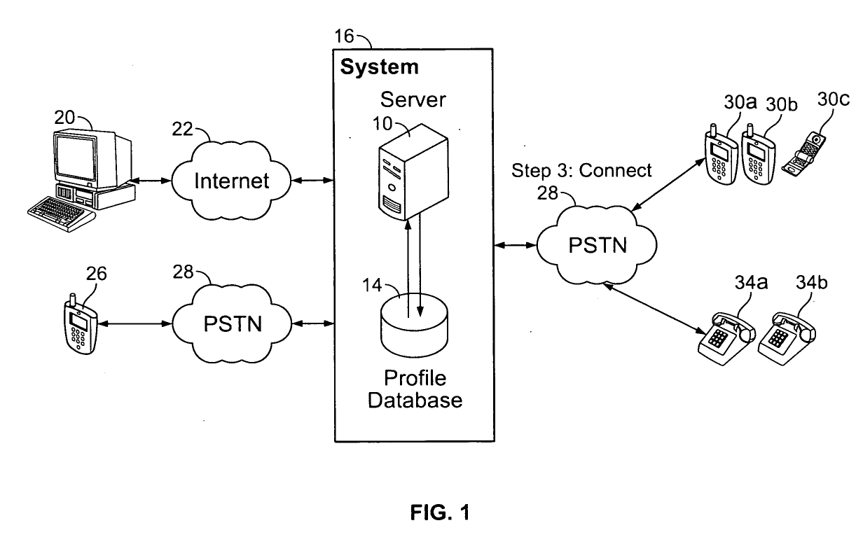

The present system and method are described here partially in the context of the Internet. The central portion of the present system is essentially a computer server-based system using a conventional client web browser for users to access it for registration. Users need no special software, or even a computer in some embodiments. The architecture of the present system is shown in FIG. 1. The central element is a conventional server 10, which host the software, which operate the system. Typically this software is written in the Java and VXML languages or equivalent. Coding the software would be routine in light of this disclosure that provides a detailed description of the steps undertaken by such software.

Server 10 interacts with the profile database application 14, which is a conventional database, for instance, of the My SQL (structured query language) type which holds the profiles (described further below) of members of the system and is hosted on the same or a different server as server 10. Hence the combination of server 10 and database 14 are the head end or central part of the system 16. All remaining elements shown in FIG. 1 are wholly conventional. They include, in the upper left had corner, the user's computer 20, which is running a conventional web browser client of the type well known in the field and connects to server 10 via the Internet 22. As described below, computer 20 and its Internet connection 22 to server 10 are used essentially for system registration and setup rather than for the actual telephone calls between the users. However, the user can also register and set up using his telephone 26 in other embodiments thereby requiring no user computer 20. Also as shown in the left hand part of FIG. 1, telephone 26 is used to telephone the system via the public switched telephone network 28. Such calls are typically for talking to other users or to request help. On the right hand side of FIG. 1 there are several other telephone users having telephones 30a, 30b and 30c. These telephone users are matched with the user of telephone 26 as described below and all users are designated “buddies”. Also shown in the lower right hand portion of FIG. 1 are additional telephones 34a, 34b also connected via the public switched telephone network 28 to the central system 16. These are telephones of designated “on-call buddies” who are available for help. Thus the distinction between the users of telephones 30a, etc. and 34a, etc. is essentially in the way they relate to the user of telephone 26.

This system provides an open platform for like-minded people to find each other and talk over the telephone without previously knowing each other or waiting for introductions. It is an attempt to flatten the barriers, quickly find the first available right person for the topic or issue at hand and talk to them. Professionals and experts can enroll with the system and provide answers and earn money from the requestor.

The process of system registration includes different sets of keywords, recording names and voice profiles, matching maximum keywords based on available time windows and ratings, playing recorded names and profiles for selection and connecting the selected option(s), billing requestors and paying help providers based on tiered rates, all described in further detail following.

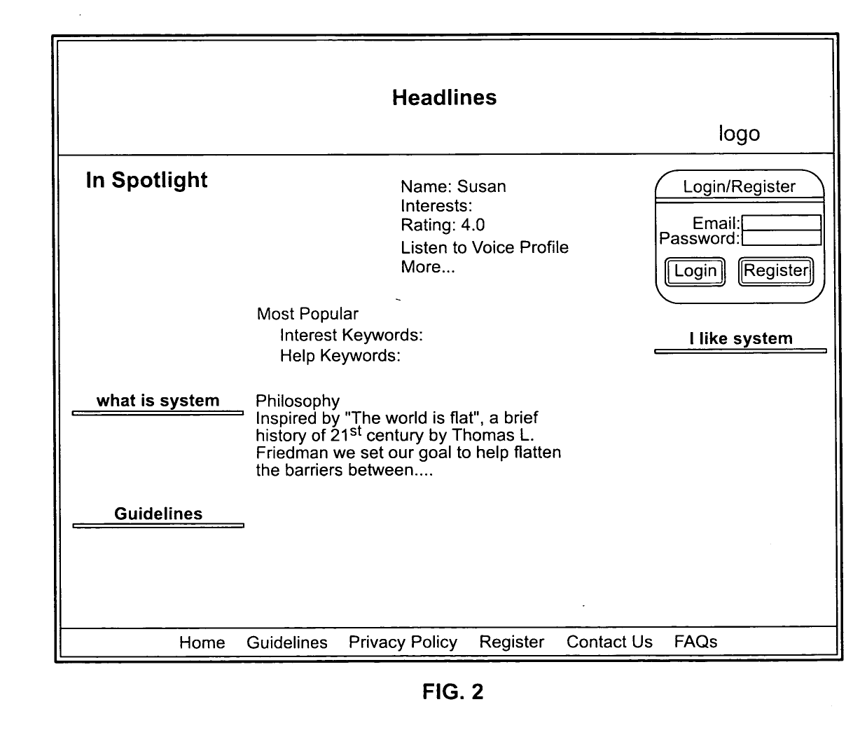

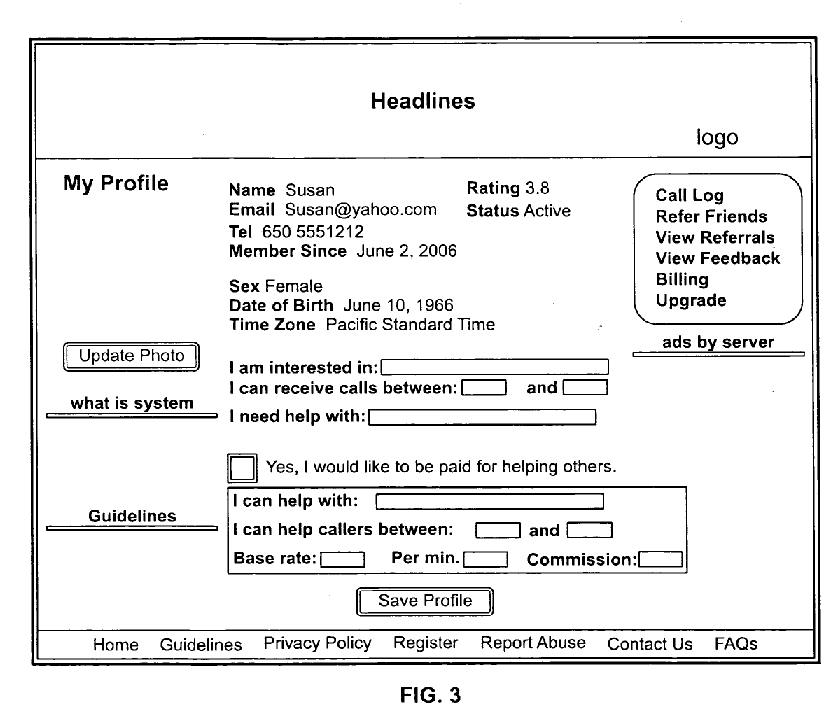

The system lets anyone with a valid email address and a telephone number register over a website or by telephone. FIG. 2 shows an exemplary home web page of the website. A new user clicks on the ‘Register’ button of the provided web page of FIG. 2 and types in her email address in the upper right, provides the system with her basic “buddy profile” information which is his telephone number and “I am interested in” keywords (limited to a few words, e.g. 5), “I need help with” keyword (limited to a few words, e.g. 5), and available to take calls from others between start and end time windows. (“Buddy” here refers to a system user.) FIG. 3 shows the basic registration web page, partly completed.

If a caller wants to become a paid “On-Call buddy” (someone who can provide help in their field of expertise), the system asks him on the web page of FIG. 3 “I can help with” keywords (limited to a few words, e.g. 5), available to take help (information or advise) request calls from others between start and end time windows, basic rate for initial duration (e.g. 3 minutes), per minute rate after the initial duration, and commission (above a minimum value by system provider) to be shared with the system provider.

The registration process can also be done over the telephone instead of the website, in spoken language where the system is automated and conventionally uses conventional speech recognition to “listen” and understand callers, and uses pre-recorded prompts and text-to-speech conversion to “speak”.

After the basic registration is completed and submitted, the new user is informed by the system of his “voiceKey” (an easily distinguishable spoken word serving as a password, or it can be voice-print which is characteristics of their own voice just like a finger print) and shown how to record his name and voice profile over the telephone by calling the system's central telephone number. This process is described in more detail hereinafter.

After a user has registered his basic buddy or “On-Call” buddy profile, he can set up his voice profile with the system over the telephone. A voice profile includes his name, and an introduction about his interests, hobbies, skills, and expertise etc., recorded in his own voice and saved in a file or database on the system.

A user can telephone the system anytime, and it answers the telephone call and helps the caller set up the voice profile, or the system can initiate the telephone call and ask the user if he would like to setup his voice profile and then help them with the process.

The system guides the user through the step-by-step process, asking him the name first, record it, plays it, and saves it when the user is satisfied with the recording. Then the system records the user's introduction, plays it, and saves it when the user is satisfied with the recording.

Users can modify their voice profile at any time after the setup. A user can also upload voice profiles recorded at home, office, or studio on his own recording equipment in pre-specified file formats.

The voice profile can be a video profile when supported by the caller's device (e.g., a picture phone or a web cam supported on a computer) and the system will record a video introduction with the spoken words.

When a user has completed registering his basic buddy or “On-Call buddy” profile, and a voice profile (including video where supported), he can start using the system to connect to others.

A user telephones a published number (local or toll-free); the system answers the call, and asks for the caller's voiceKey. If the caller presents the correct voiceKey (this can be a voice-print which is characteristics of their own voice just like a finger print), the user is authenticated. The system will then interact with him via telephone by way of pre-recorded prompts, and text-to-speech conversion. It asks them the purpose of their call, telling them options, such as “Search” for new buddies, talk to “Favorite” buddies, or ask for “Help”.

If the caller wants to “Search” for new buddies, the system looks up his “I am interested in” keywords and finds the maximum word matches with others who are available to take calls at that time based on their call-window, and ratings. It presents the top few choices (e.g. three), plays their names and voice profiles and asks the caller to whom they wish to be connected. If the caller picks a name from the list, the system then connects the caller with the selected buddy; otherwise it presents them with more options.

If the caller wants to talk to “Favorite” buddies, the system looks up his “Favorite” buddy list and checks to see who is available to take calls at that time based on their call-window. It presents the top few choices (e.g. three), plays their names and/or voice profiles and asks the caller to whom they wish to be connected. If the caller picks a name from the list, system then connects the caller with selected “Favorite” buddy; otherwise it presents them with more options.

If the caller wants to obtain “Help”, the system looks up his “I need help with” keywords and finds the maximum word matches with On-Call buddies' “I can help with” keywords who are available to take calls at that time based on their call-window, the commission they agreed to share with system, and ratings. It presents the top few choices (e.g. three), plays their names and voice profiles, basic and per minute rates, and asks the caller to whom they wish to be connected. If the caller picks a name from the list, the system then connects the caller with selected On-Call buddy; otherwise it presents him with more options.

Callers can modify their “I am interested in”, or “I need help with” over the telephone by naturally talking to the system, to dynamically search for new buddies or ask for help from “On-Call” buddies, all without first having to go to the system website. Based on the caller's preferences, the system will play these (just) recorded keywords for the On-Call buddy to listen and decide whether they think they are the right match to answer the caller's question(s). If the On-Call buddy says “No” when asked, the caller is not connected to this On-Call buddy and the system offers them the next option.

If there is no one available to take this call based on the keywords and call-windows, the system will check to see if the caller wants to be put in a queue (described below) for the first available match and then get a call back later when they are on top of the queue.

The caller does not see or hear any personal information about the called party, and the called party does not see who this call is from in their telephone's caller ID display. The caller calls the system, so he only knows the system's contact number, and the called party sees only the system's information on his caller ID display. Based on user preferences, the system will announce the name of the caller to the called party.

The system will maintain a queue of callers along with their help questions if any, who to select to talk to another person, and connect them when the call window of the receiving person starts. Callers can put themselves in this queue via telephone or over Internet via the website.

The system notifies people in the queue when it connects the person before them (to the On-Call buddy) and confirms that they are still interested and available to talk in the next few minutes. If a person wishes to remove himself, he can do so. If the person does not answer the telephone call also, they are removed from the queue.

When the time-window starts for an On-Call buddy, the system checks to see if there were any callers waiting in the queue to be connected to this buddy. If there are, it prioritizes so these callers are connected first and disables the connect anytime method (described above) even though the receiving buddy's call window has started.

The system initiates the call to the receiving buddy and it plays each caller's question or voice profile and if the receiving buddy decides to talk to this queued caller, they are connected. After the call is over, the connection goes to the next caller in the queue.

When there is no one left in the queue, the system disconnects the “On-Call” buddy and switches its priority for this “On-Call” buddy to the connect-anytime-method (described above).

The system has a provision for “On-Call” buddies to offer their call window to multiple simultaneous users, thereby facilitating a class or training-type conference call with a live question and answer session, with those users sharing the cost depending on connected time. The payment rate for such an over-the-phone-class is set by the On-Call buddy, e.g. as base rate and per minute rate.

The system has provision for like-minded buddies to use their call window to invite multiple simultaneous favorite buddies from their list for a virtual party-like conference telephone call. The invitees can join, listen, and talk to other buddies at the virtual party or initiate their own private talk sessions with some of those attending. Everyone who joined the party can listen to other people's voice profile. This will include video streaming, when supported by a buddy's device (e.g., picture phone).

The system recognizes different levels of user, e.g. most basic being free membership allowing a person to call and search for like-minded buddies based on their profile for a limited number of minutes per month, such as during a promotion. When the basic level buddy selects “I need help with” option, he must provide his billing information, e.g. credit card details, before being connected to the “On-Call” (or help provider). Other levels of users can pay a monthly fee for a limited number of included minutes. These minutes are counted when they are actually connected to other (favorite, new, or On-Call) buddies and not for profile administration or while listening to the menus and making selections etc.

The system also lets people sign up to be an On-Call buddy, provide advice based on “I can help with” keywords, and earn money for all connected caller requests. The rates they set are based on system allowed limits and their own ratings. They specify a base rate for an initial duration (e.g., first three minutes), per minute after initial duration for a single caller, and multiple simultaneous callers, and a commission to the service provider based on minimum and maximum set by the service provider.

For class or training style conference call or virtual parties hosted by buddies, the system's billing process keeps track of who was connected for how long to bill each caller's account for such minutes in addition to any basic rate.

The system credits accounts of “On-Call” buddies with their earnings from providing answers to callers with help requests, based on basic rate, per minute rate and after deducting commissions paid to the (system's) service provider agreed in advance. An accounting module will then use these records to actually send a payment to the “On-Call” buddy on previously agreed upon frequency (e.g. every quarter).

Other streams of revenues for the (system's) service provider include keyword based voice ad placement during calls. This is very helpful; if users who have free membership agree to listen to such ads, sponsors will likely help pay for their memberships.

The system is thus a social and professional networking platform. One searches for people who share same interests and talk to them over the telephone. One helps others over the telephone and earns money. This is done without necessarily disclosing one's telephone number or any personal information.

There are three main elements participating in the present method, as seen in FIG. 1. Their roles and responsibilities are:

Buddy

1. A user who registers with the system, providing just an email address and telephone number.

2. Presented with a link to the profile completion section, voiceKey, and instructions on how to setup a brief (e.g. 15-second) voice profile.

3. Can modify the profile, upload picture, modify “I am interested in” and “I need help with” keywords etc., anytime online after login.

4. Specifies time windows when he is available to take calls from other buddies.

5. Has ability to become an On-Call buddy.

6. Can recover his password by clicking the forgot password link.

7. Records his first name and sets up a voice profile over the telephone as per instructions published online or sent via email.

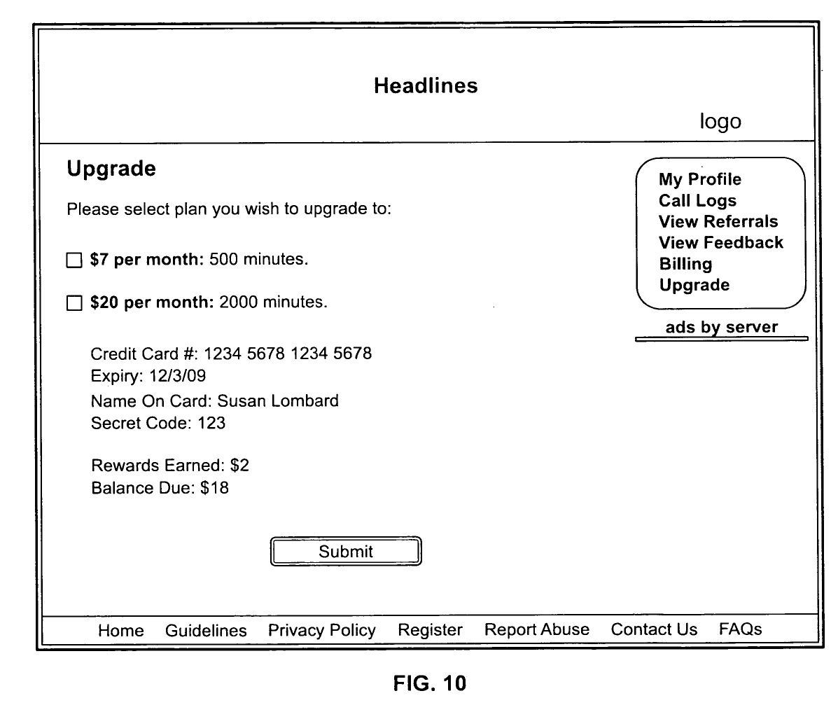

8. Can upgrade by accessing the website from a free membership (for a limited number of total minutes each month for the promotion duration) to paid membership of e.g. $7 (for more minutes) or $20 for (even more, almost) unlimited minutes per month (see FIG. 10) via the website, or by telephone.

9. Calls the system number, and talks to other buddies from his favorites list, searches new matches from “I am interested in” matching, or “on-call” buddies from “I need help with” keywords.

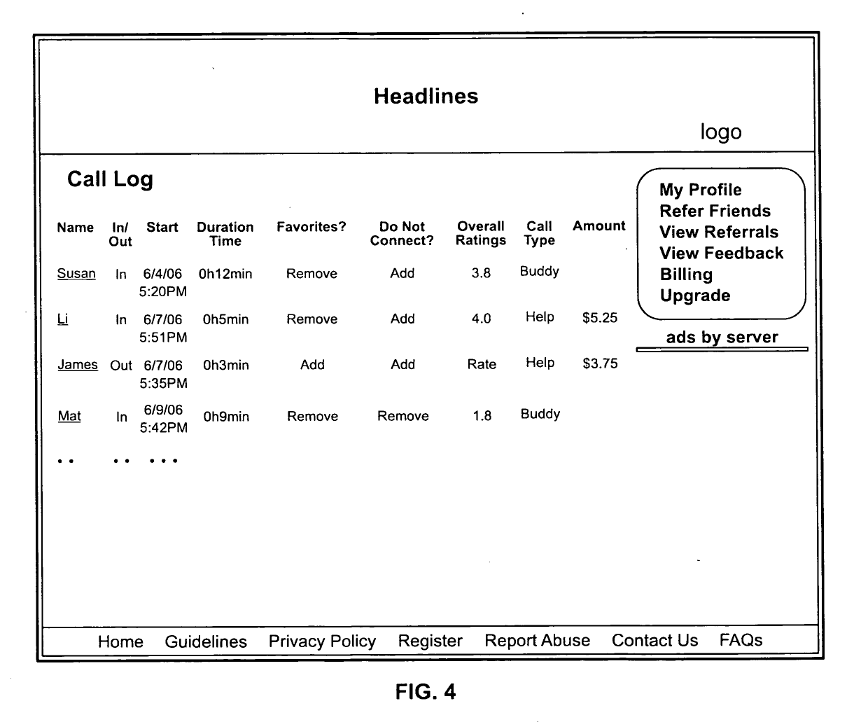

10. Views the log of past telephone calls (see FIG. 4) via the website or hears the audibilized log over the telephone.

11. Views buddies' call windows.

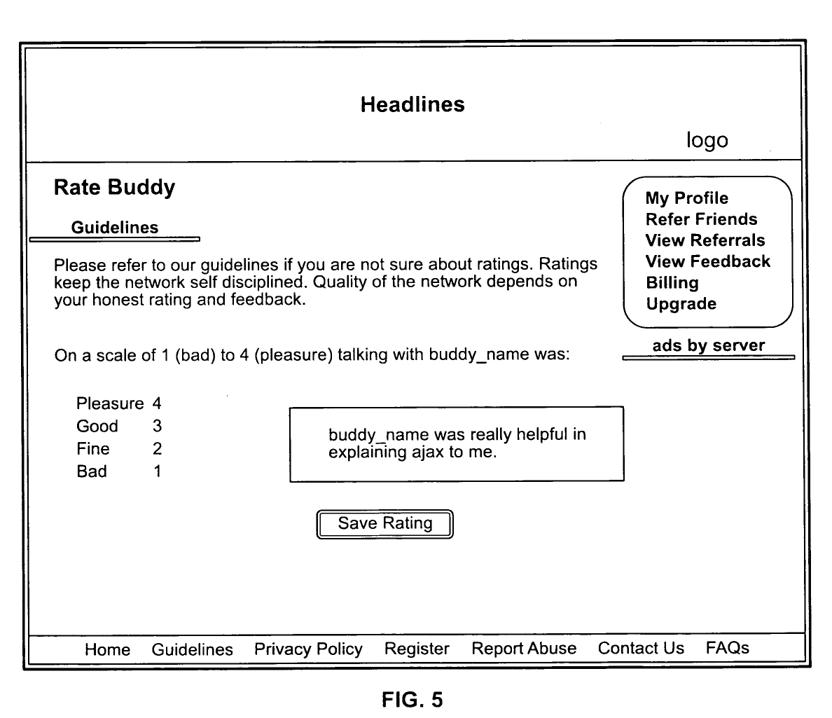

12. Rates (see FIG. 5) via the website or by telephone input (on a scale of 1 to 4) and leaves feedback for buddies previously connected to, and earns online rewards (e.g. more minutes).

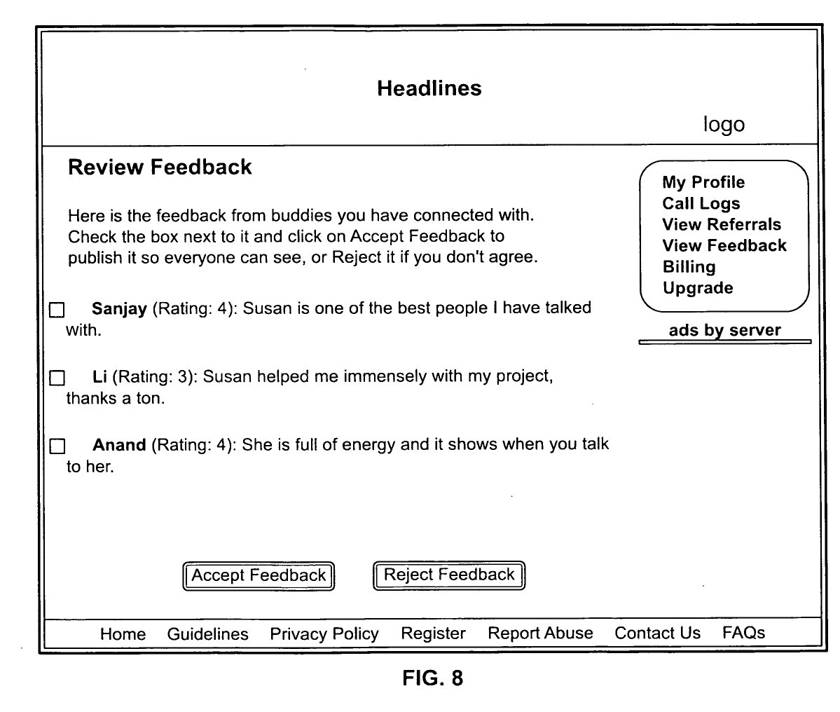

13. Accepts feedback (see FIG. 8) left by his buddies to be published for others to view. This may be made private.

14. Adds (or Removes) buddies to favorite list, still without disclosing personal information such as telephone number or email address to each other.

16. Adds (or Removes) buddies to his “Do Not Connect” list, without disclosing personal information such as telephone number or email to each other. This allows each buddy to have the system block calls from any undesired other buddies.

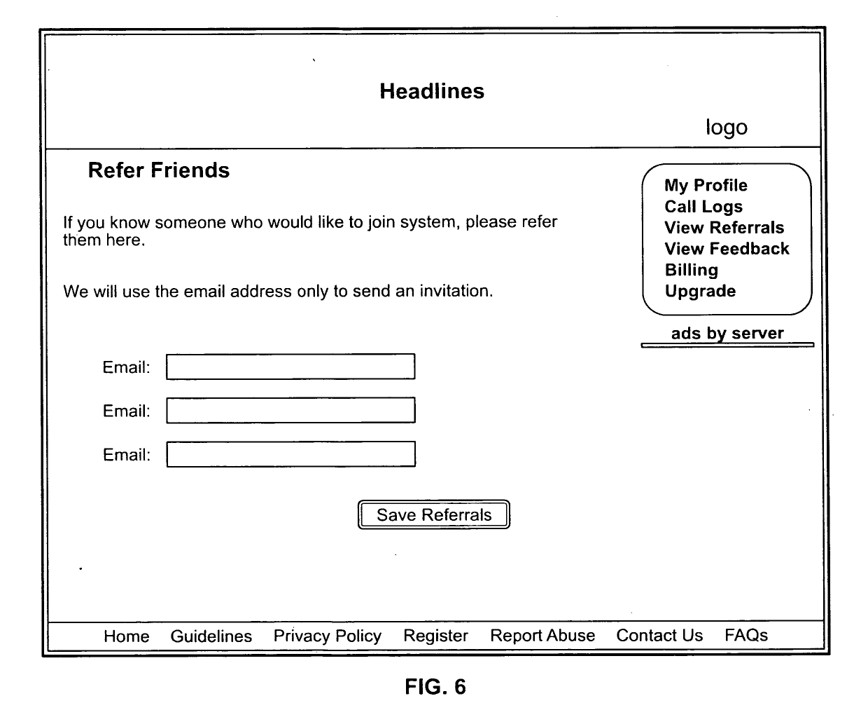

17. Refers friends and family and earns online rewards (e.g. more minutes) (see FIG. 6).

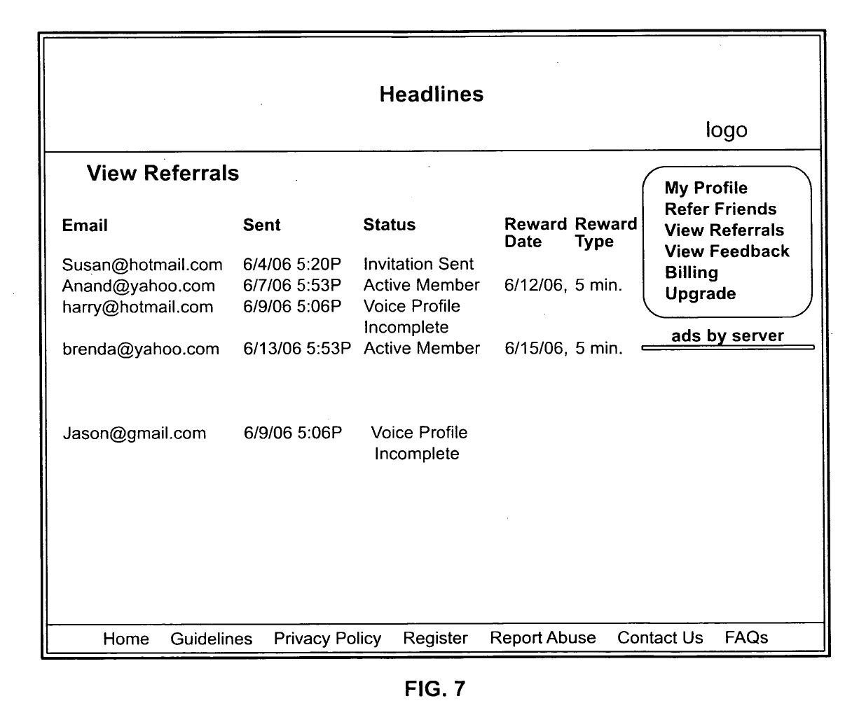

18. Checks status of past referrals whether they have accepted an invitation and joined the system or not, and their membership status (see FIG. 7). A buddy can receive an invitation (via email, text message, or recorded voice call) from other buddies who wish to call that user, prior to the actual call. After the invitation is accepted, either buddy can initiate the call.

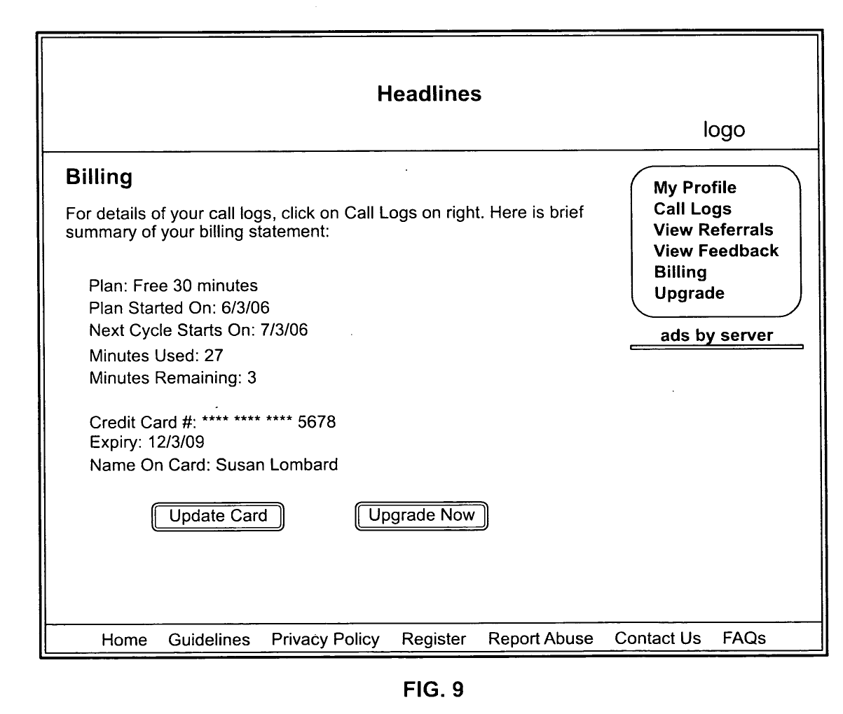

19. Views billing data (see FIG. 9), e.g. minutes used and balance remaining, plan start date, next payment date.

20. Views rewards earned online, e.g. additional minutes, dollar discounts, and additional month of free subscription etc.

On-Call Buddy

1. A type of user who can do anything that a regular buddy can do.

2. Professionally answers questions from other buddies over the telephone and earns money.

3. Specifies his base compensation rate for initial duration, per minute rate after initial rate for single or multiple simultaneous users, and commission paid to system (minimum set by system) for providing answers or help over the telephone.

4. Specifies “I can help with” keywords.

5. Specifies separate call windows for being “On-Call” to help answer questions and earn money.

System

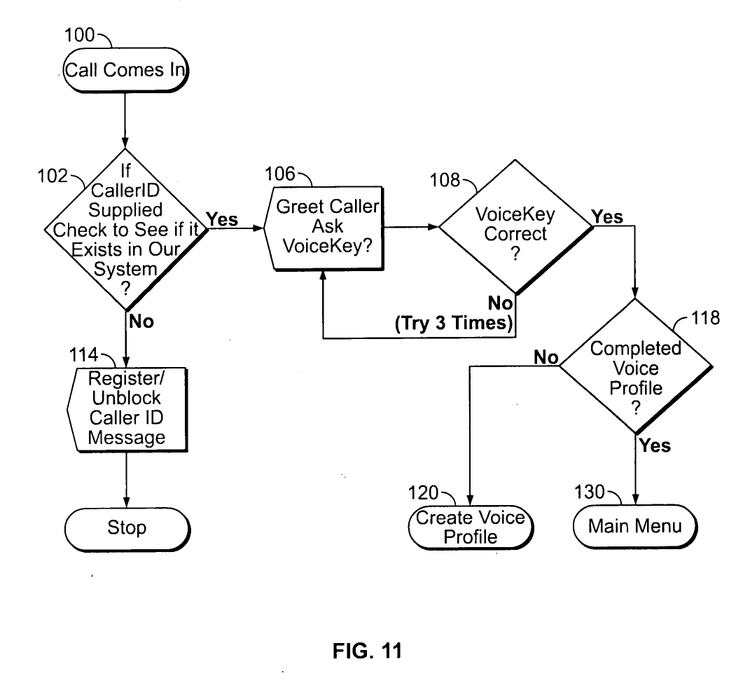

Operation of system 16 of FIG. 1 is shown in flow chart form in FIG. 11, and is as follows:

1. A telephone call comes in to the system at 100 and it answers the ringing local number after a configured number of rings.

2. If the caller ID (or ANI) suggests the caller is an existing customer at 102, greets them, e.g. “Good morning, Robert” at 106 and verifies the voiceKey at 108.

3. If this is the first time a caller is calling after creating profile online at the system website, walks him through the first name and voice profile setup at 118, 120.

4. If the caller is not identified or his Caller ID is suppressed at 114, prompts him to register online with the system site and dial, e.g. *82 before calling again, or helps them register interactively over the telephone.

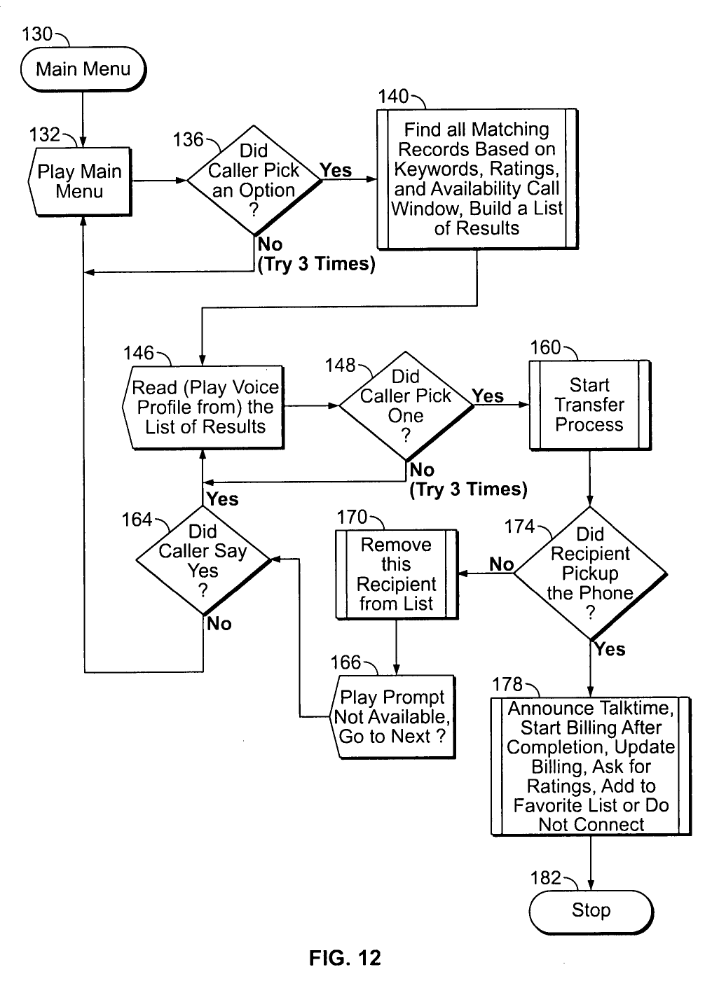

5. If the caller is registered and has already created a voice profile before, asks her via the main menu at 132 (see FIG. 12) if she would like to talk to someone from her favorite buddy list, search for a new buddy, or connect to an on-call buddy for help with her own “I need help with” keywords. Both types of searches (buddy with similar interests, and On-Call buddy for help) can be changed by speaking new keywords naturally in a human voice over the telephone. The system recognizes speech and modifies the searches based on these new keywords.

The call processing in the remainder of FIG. 12 is largely conventional for automated telephone voice recognition systems. At 138, the caller picks an option from main menu 132. When he does, the system at 140 finds the matching records in the system database (see FIG. 1). The results (a list of buddies) are played to the caller at 146. The caller picks one of the played results at 148. Then the transfer process at 160 places a call to the selected result (a buddy). If the call recipient answers at 174, the call process is carried out at 178, ending at 182. If the callee does not answer at 174, the next potential buddy is presented at 166, and the caller responds at 164, returning to 146.

6. If the caller picks favorite buddy from the main menu, presents a short list of available ones based on their call windows.

7. If the caller picks search for new buddy, presents the top few (e.g. three) matches by stating names and plays their 15-second voice profile and connects with the one selected by the caller by speaking the name from the list or sequence they were presented in.

8. If the caller decides to ask an “On-Call” buddy for help, presents the top few (e.g. three) matches based on “I need help with” keywords from the caller's profile and “I can help with” keywords from the “On-Call” buddy's profile and “On-Call” windows of help provider. Both types of searches (buddy with similar interests, and On-Call buddy for help) can be changed by speaking new keywords naturally in a human voice over the telephone. The system recognizes speech and modifies the searches based on these new keywords. Tells caller the first name, base and per minute rate, then play the voice profiles. Tells the called party that this is a help request by way of caller ID.

9. In all cases of presenting a list of top few (e.g. three) items at 138 if the caller doesn't pick one, the system plays the next item. If the caller doesn't pick any of the top few, the system then presents next set of top few at 132 based on keyword matching and ratings. All interaction at this point between the caller and the system is via spoken words and conventional speech recognition processes and logic.

10. If an On-Call buddy was included in the connection, writes the debit and credit amounts to called and caller party based on the rates specified by the called party.

11. When the call ends, completes data collection routines and asks the caller for his rating of called party and thank the caller for using system and says “goodbye”.

12. Lets members log in to the system website using their email address and password, and recover their password by email.

13. Displays a history of calls in/out, from datetime, to datetime, other party's first name, call windows, available now, rankings, and status in their own “Favorites” or “Do Not Connect” list. For instance, free buddies see only the current month history, while paying buddies see the past 180-day history.

14. Lets buddies rank other buddies from their connected list on a scale of 1 to 4 anytime online.

15. Lets buddies report inappropriate pictures or voice profiles in other buddy profiles and earn online rewards (e.g. more minutes).

16. Lets the system website administrator view newly created profiles, including photos and listen to voice profiles.

17. Lets the system website administrator select the most popular profile and keyword searches and publish them on spotlight on home page.

18. Lets the system website administrator remove objectionable pictures from database and reset that buddy rating to 0.

19. Lets every (pre) registered user refer their friends, and when the referred friend registers they earn online rewards (e.g. more minutes).

20. Lets each buddy record voice reminders to be delivered at pre-specified time over the telephone.

21. Refers buddies who have specified “I need help with” keywords to matching On-Call buddies who have specified all or some of the same keywords in “I can help with” keywords.

22. Saves information on help requests that were not completed because the On-Call buddy (help provider) was unavailable or busy on the telephone, and shares those records with On-Call buddy for a fee.

23. Provides a mechanism to alert an On-Call buddy if there is another help request coming/waiting and lets him choose to switch or put that new person in a queue.

24. Connects the “On-Call” help provider with callers with help requests waiting in the queue at a later time when both are available.

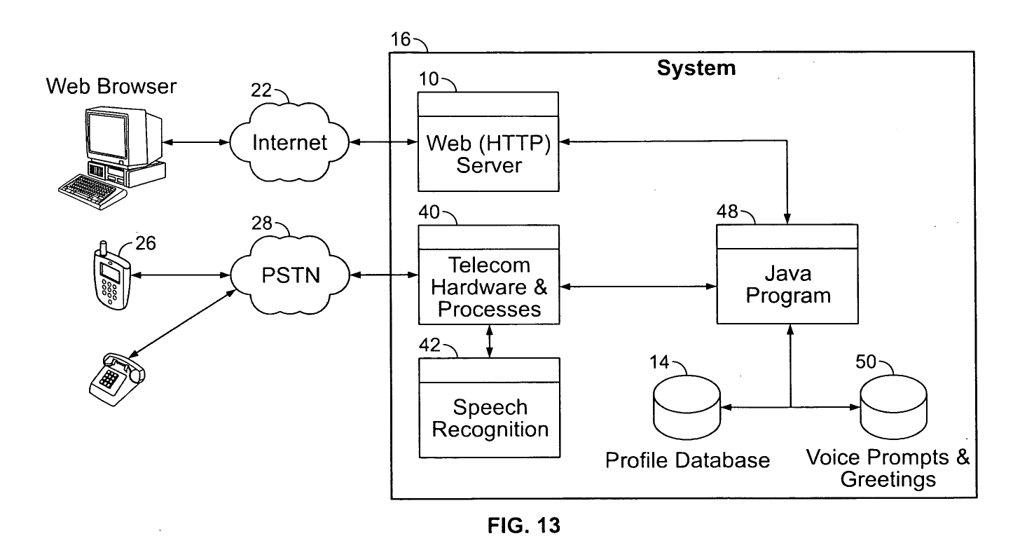

FIG. 13 shows additional detail of the present system, portions corresponding to those of FIG. 1, in accordance with the above description. Additionally depicted in FIG. 13 is that the server 10 is a web (HTTP) server, which interacts with the database 14 and voice prompts and greeting which are also stored in computer memory at 50, via a computer program (software) 48 coded in the Java language or equivalent. Also shown are the speech recognition hardware and software 42 for the voice interaction aspect of the system, and also the telecommunications circuitry and software 40 also for the telephone aspects.

The above description is illustrative but not limiting; further modifications will be apparent to those skilled in the art in light of this disclosure and are intended to fall within the scope of the appended claims.

What is claimed as new and desired to be protected by Letters Patent of the United States is:

1. A computer enabled method, comprising the acts of:
registering a profile of each of a plurality of users;
organizing the registered profiles into a database, storing the database in a computer memory;
receiving a request from a requesting user for contact with one of the registered users;
searching the database for a plurality of registered users matching criteria specified by the requesting user;
presenting to the requesting user information pertaining to at least one of the matching users; and
upon acceptance by the requesting user, connecting the requesting user to the presented matching user by telephone.

2. The method of claim 1, wherein the only identifying information of the registered users presented to the requesting user is that specified in the profile.

3. The method of claim 1, wherein the telephone connecting does not identify the requesting user to the matching user who is called, or the matching user who is called to the requesting user.

4. The method of claim 1, wherein each profile includes specification of times when the registered user will accept telephone calls.

5. The method of claim 1, wherein at least one profile includes specification of a request for payment.

6. The method of claim 5, wherein the request for payment includes a base amount and a charge per time unit.

7. The method of claim 1, further comprising the act of:
the requesting user providing a rating of the presented registered user to whom he is connected.

8. The method of claim 7, further comprising the act of:
compiling a plurality of ratings for each registered user; and
making the compilation available.

9. The method of claim 1, wherein the registering is performed over a computer network or by a telephone call.

10. The method of claim 1, further comprising the act of accepting payment from a registered user.

11. The method of claim 1, wherein the request is a telephone call or via a website.

12. The method of claim 1, wherein the criteria include at least one of times for accepting telephone calls, user ratings, and search preferences.

13. The method of claim 4, wherein the act of connecting the requesting user adjusts for a time zone indicated in the profile of the matching user.

14. The method of claim 1, further comprising the act of:
sending an invitation from a requesting user to a matching user prior to the connection, wherein after acceptance, either the requesting user or matching user initiates the connecting by telephone.

15. The method of claim 1, further comprising the act of:
blocking calls to a registered user blocks from a requesting user.

16. The method of claim 1, further comprising:
maintaining a queue of requesting users for a particular registered user; and connecting each requesting user to the particular registered user in an order determined by the queue.

17. The method of claim 1, further comprising the act of:
providing a link on a website providing at least some profile information for a registered user;
wherein invoking the link connects to the registered user by telephone.

18. The method of claim 1, further comprising the acts of:
providing access to the requesting user to search the database via a website associated with the database;
presenting the information found in the searching, including an audible presentation of a message for each registered user, via the website; and
providing the accepting by the requesting user via the website.

19. A computer readable medium storing computer code for carrying out the method of claim 1.

20. A computer programmed to carry out the method of claim 1.

21. A system comprising:
a server adapted to:
register a profile of each of a plurality of users;
organize the registered profiles into a database;
receive a request from a calling user for contact with one of the registered users;
search the database for a plurality of registered users matching criteria specified by the requesting user;
present information to the calling user pertaining to at least one of the matching users;
accept a selection by the requesting user;
connect the requesting user to the presented matching user by telephone; and
a computer memory adopted to store the database and coupled to the server.

22. The system of claim 21, wherein the only identifying information of the registered users presented to the requesting user is that specified in the profile.

23. The system of claim 21, wherein the telephone connecting does not identify the requesting user to the user who is called, or the user who is called to the requesting user.

24. The system of claim 21, wherein each profile includes specification of times when the registered user will accept telephone calls.

25. The system of claim 21, wherein at least one profile includes specification of a request for payment.

26. The system of claim 25, wherein the request for payment includes a base amount and a charge per time unit.

27. The system of claim 21, wherein:
the requesting user providing a rating of the presented registered user to whom he is connected.

28. The system of claim 27, wherein:
the server compiles a plurality of ratings for each registered user; and
makes the compilation available.

29. The system of claim 21, wherein the registering is performed over a computer network or by a telephone call.

30. The system of claim 21, further comprising an element for accepting payment from a registered user.

31. The system of claim 21, wherein the request is a telephone call or via a website.

32. The system of claim 1, wherein the criteria include at least one of times for accepting telephone calls, user ratings, and search preferences.

33. The system of claim 21, wherein the act of connecting the requesting user adjusts for a time zone indicated in the profile of the matching user.

34. The system of claim 21, further comprising:
the system sending an invitation from a requesting user to a matching user prior to the connection, wherein after acceptance, either the requesting user or matching user initiates the connecting by telephone.

35. The system of claim 21, further comprising:
the system blocking calls to a registered user blocks from a requesting user.

36. The system of claim 21, further comprising:
the system maintaining a queue of requesting users for a particular registered user; and connecting each requesting user to the particular registered user in an order determined by the queue.

37. The system of claim 21, further comprising:
a link on a website providing at least some profile information for a registered user;
wherein invoking the link connects to the registered user by telephone.

38. The system of claim 21, further comprising:
the system providing access to the requesting user to search the database via a website associated with the database;
presenting the information found in the searching, including an audible presentation of a message for each registered user, via the website; and
providing the accepting by the requesting user via the website.

39. A computer readable medium storing computer code for carrying out the system of claim 21.

40. A computer programmed to carry out the system of claim 21.
